(19) United States
(12) Patent Application Publication
(10) Pub. No.: US 2004/0146267 A1
(43) Pub. Date: Jul. 29, 2004

(54) Photonics device assembly process carrier

(76) Inventors: Cathal Flanagan, Mission Viejo, CA (US); Kirk Matthes, Fountain Valley, CA (US); Randy Heyler, Newport Beach, CA (US)

Correspondence Address: IRELL & MANELLA LLP, 840 NEWPORT CENTER DRIVE, SUITE 400, NEWPORT BEACH, CA, 92660, US

(21) Appl. No.: 10/350,481

(22) Filed: Jan. 23, 2003

(51) Int. Cl. G02B 6/00

(52) U.S. Cl. 385/147

(57) ABSTRACT

Disclosed is a fiber loading station that is used to load and align a fiber optic cable into a fiber chuck assembly. The fiber chuck assembly and aligned fiber are mounted to a pallet that can be loaded into a package assembly station such as a laser welder. The laser welder can solder the fiber to a package of a fiber module. The fiber is pre-aligned within the loading station so that the operator of the package assembly station does not have to waste time aligning the fiber with the package in the laser welder. One fiber may be loaded at the loading station while another fiber is being soldered to a package in the laser welder. Having a separate fiber loading station allows a production facility to both align fiber and solder fiber to a package in a parallel overlapping process. This reduces the assembly time, increases throughput and decreases assembly cost to manufacture a photonic package.

### BACKGROUND OF THE INVENTION

1. Field of the Invention

The present invention relates to pallets and workstations for assembling fiber optic modules.

2. Background Information

Fiber optic networks typically contain a number of optical fibers interconnected by various routers, computers, switches, etc. Information is transmitted through the fibers by photo-emitters such as laser diodes. The laser diodes emit light that travels through the fiber to a photo-detector.

The end of an optical fiber is typically coupled to the photo-emitter or photo-detector in an electronic package sometimes referred to as a fiber optic module. The package may contain a platform that supports the emitter/detector and an outer metal housing to protect the optical components. The end of the optical fiber can be soldered to the platform to attach the fiber to the package. It is critical to accurately align the fiber with the emitter/detector during the solder process to minimize the optical power losses in the system.

The fiber is typically soldered to the package with one or more lasers of a laser weld machine. The laser weld machine has tooling fixtures that hold the package and fiber in place during the weld process. The fiber optic cable is inserted through a snout of the module housing before being soldered to the package. Inserting the ferrule through the housing snout can be a time consuming process similar to threading a needle.

Application No. 973, 126, filed on Oct. 8, 2001 and assigned to the same assignee, discloses a laser weld station with a sub-station that loads a fiber optic cable into a fiber module package. The laser weld station includes a camera that allows the operator to adjust the position of the fiber optic cable relative to the emitter/detector. Some fibers require a certain angular orientation relative to the package to insure an optimum optical coupling between the fiber optic cable and the photonic device. The station also includes a thumb wheel that can be rotated to create proper angular orientation of the fiber with the package.

Unfortunately, it takes time to accurately align the fiber within the welding station. The time required to align the fiber increases the production time, decreases the throughput of the manufacturing facility and ultimately increases the cost of the producing the package. It would be desirable to provide a station and method for loading the fiber optic cable into the weld machine so that the fiber is already properly aligned when loaded.

### BRIEF SUMMARY OF THE INVENTION

A fiber loading station that includes a fiber chuck assembly supported by a base station. The fiber loading station may also include a first camera located above the base station and a second camera located in front of the base station.

### BRIEF DESCRIPTION OF THE DRAWINGS

FIG. 1 is a side view of a fiber loading station;

FIG. 2 is a front top perspective view of the fiber loading station;

FIG. 3 is a front top perspective view of a fiber chuck assembly;

FIG. 4 is a cross-sectional view of the fiber chuck assembly;

FIG. 5 is an exploded view of the fiber chuck assembly;

FIG. 6 is an enlarged top view showing a positioning of the fiber optic cable within the fiber loading station;

FIG. 7 is a front view showing an angular orientation of the fiber optic cable within the fiber loading station;

FIG. 8 is a front top perspective view showing the fiber chuck assembly being unloaded from the fiber loading station;

FIG. 9 is a front top perspective view of the fiber chuck assembly loaded into a pallet.

### DETAILED DESCRIPTION

Disclosed is a fiber loading station that is used to load and align a fiber optic cable into a fiber chuck assembly. The fiber chuck assembly and aligned fiber are mounted to a pallet that can be loaded into a package assembly station such as a laser welder. The laser welder can solder the fiber to a package of a fiber module. The fiber is pre-aligned within the loading station so that the operator of the package assembly station does not have to waste time aligning the fiber with the package in the laser welder. One fiber may be loaded at the loading station while another fiber is being soldered to a package in the laser welder. Having a separate fiber loading station allows a production facility to both align fiber and solder fiber to a package in a parallel overlapping process. This reduces the assembly time, increases throughput and decreases assembly cost to manufacture a photonic package.

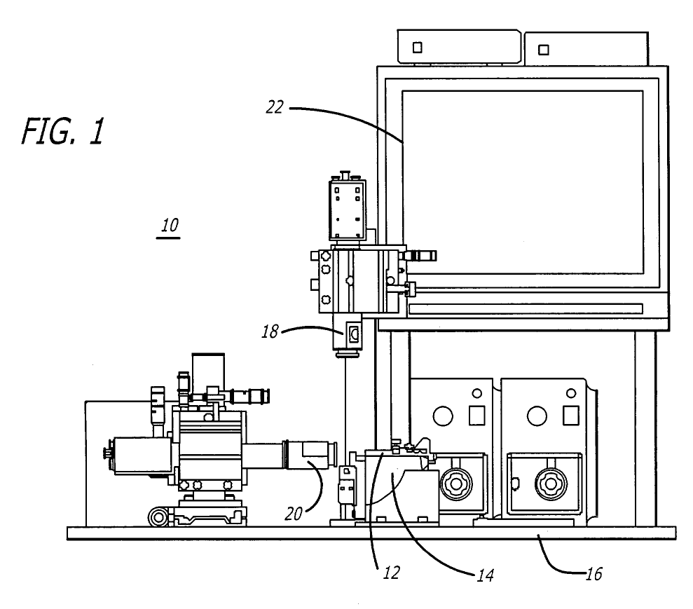

Referring to the drawings more particularly by reference numbers, FIG. 1 shows a fiber loading station 10. The fiber loading station 10 includes a fiber chuck assembly 12 located on top of a base station 14. The base station 14 may be mounted to a table top 16 located within a test and/or manufacturing facility. The loading station 10 may further have a first camera 18 located above the base station 14 and a second camera 20 located in front of the base station 14. The cameras 18 and 20 may be connected to a monitor 22.

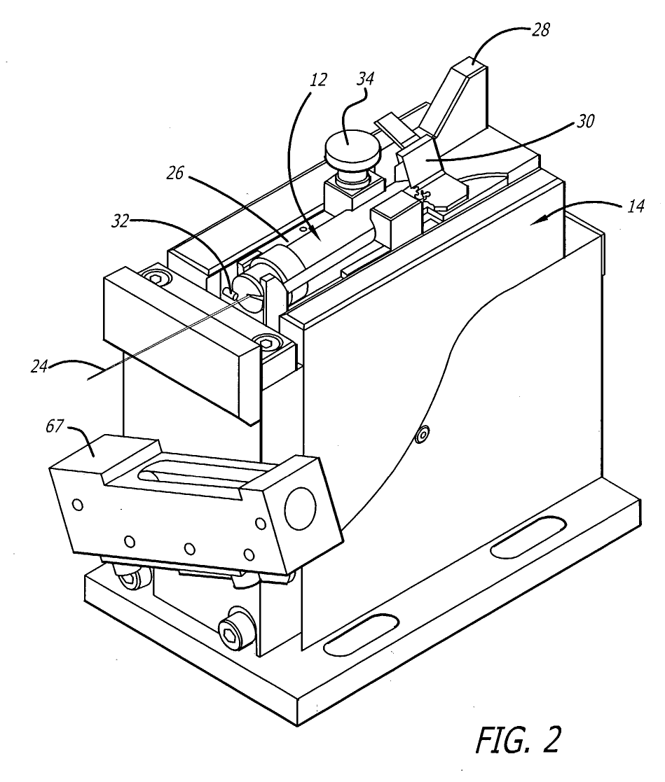

As shown in FIG. 2, the fiber chuck assembly 12 holds a fiber optic cable 24 that is aligned within the fiber loading station 10. The chuck 12 may be mounted to a fiber chuck substrate 26. The chuck substrate 26 and chuck 12 can be lifted and readily removed from the base station 14 after the fiber cable 24 has been aligned within the fiber loading station 10. The substrate 26 may include a handle 28 to facilitate removal of the chuck 12 from the base station 14. The substrate 26 may also have a clip 30 that restrains a portion of the fiber optic cable 24. The chuck substrate 26 may have a stop pin 32 to provide a Z-direction stop for the chuck assembly 12 and a clamp 34 that secures the chuck 12 within the substrate 26. The chuck 12 is spring biased into the pin 32.

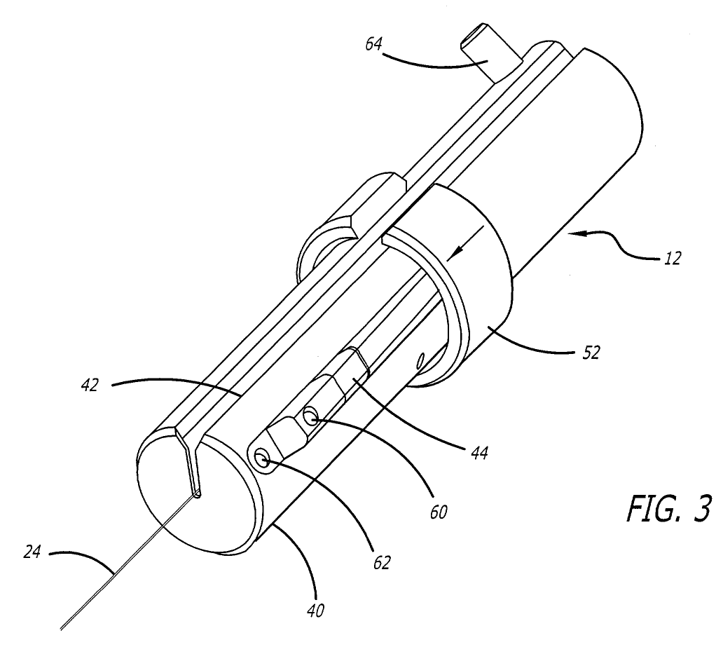

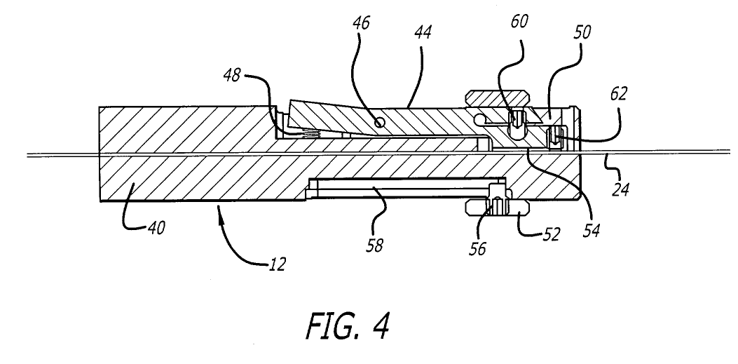

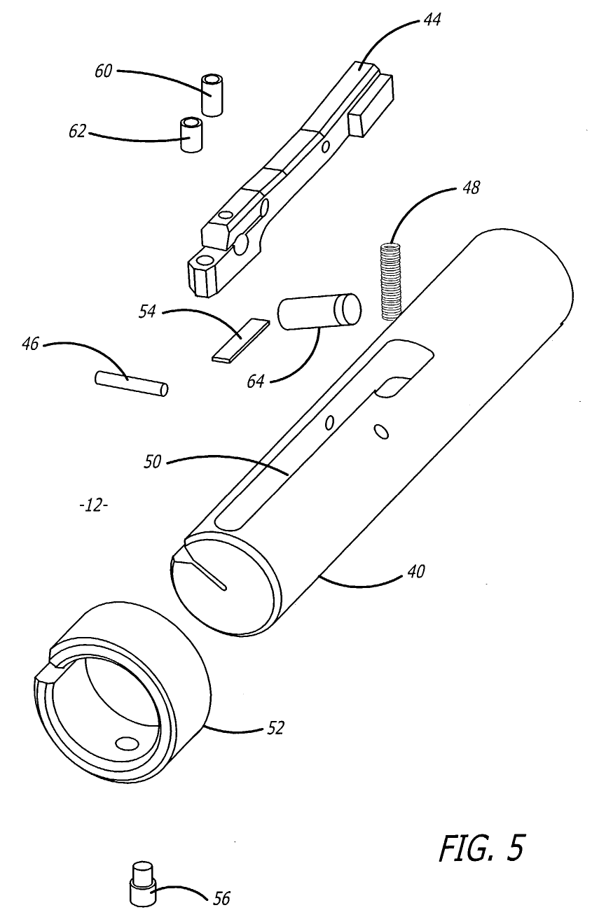

FIGS. 3, 4 and 5 shows an embodiment of the chuck assembly 12. The chuck assembly 12 may include a housing 40 that has a slit 42. The fiber optic cable 24 is placed into the slit 42 of the housing 40. The chuck assembly 12 may also have a lever 44 that can be moved into a locked position, an unlocked position or a slight pressure position. The lever 44 rotates about a pin 46 and is biased into the slight pressure position by a spring 48. The lever 44, pin 46 and spring 48 are located within a cavity 50 of the housing 40.

The chuck assembly 12 may further have a collar 52 that can slide along the housing 40 and move the lever 44 between the locked, unlocked and slight pressure positions. In the locked position the lever 44 applies a pressure to the fiber optic cable 24 and maintains the position of the fiber 24. The lever 44 may have an elastomeric pad 54 that makes contact with the fiber 24. The elastomeric properties of the pad 54 may prevent damage to the fiber 24 from the pressure of the lever 44. The collar 52 may be captured by a screw 56 that slides along a slot 58 in the housing 40.

The lever 44 may have a first set screw 60 that can be turned to adjust the force exerted onto the fiber optic cable 24. Turning the set screw 60 in a downward direction will increase the force. The lever 44 may also have a second set screw 62 that can redirect the fiber optic cable 24 underneath the pad 54. The point where the pad 54 terminates may cause a bend in the fiber 24. The second set screw 62 deflects the end of the lever 44 and bends the fiber cable 24 so that the fiber 24 extends from the chuck 12 in a straight manner. The fiber chuck assembly 12 may also include a handle 64 to allow an operator to easily load and unload the chuck 12 and the chuck substrate 26 from the base station 14.

In operation, the collar 52 is moved to the middle of the housing 40 so that the lever 44 is pressed into the unlocked position. The fiber optic cable 24 is then loaded into the slit 42 of the housing 40. The collar 52 is then moved in an outward direction as indicated by the arrow so that the lever 44 applies a small amount of pressure to the fiber optic cable 24. The fiber chuck 12 and chuck substrate 26 are then loaded onto the base station 14.

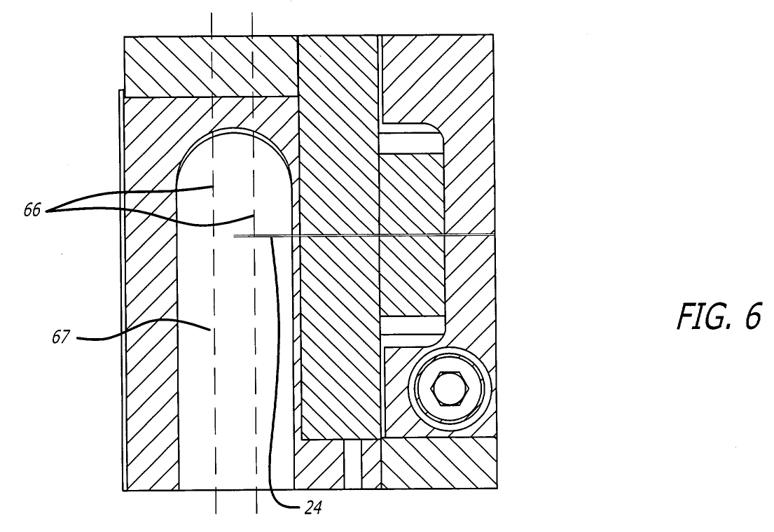

As shown in FIG. 6, the operator can view the end of the fiber optic cable 24 relative to a pair of visual markers 66 through the first camera 18 and monitor 22. The markers 66 may be attached to the first camera 18 and illuminated by a backlight 67. The operator can manually move the fiber cable 24 until the end of the fiber 24 is between the markers 66. This provides an accurate positioning of the fiber 24 along a z direction.

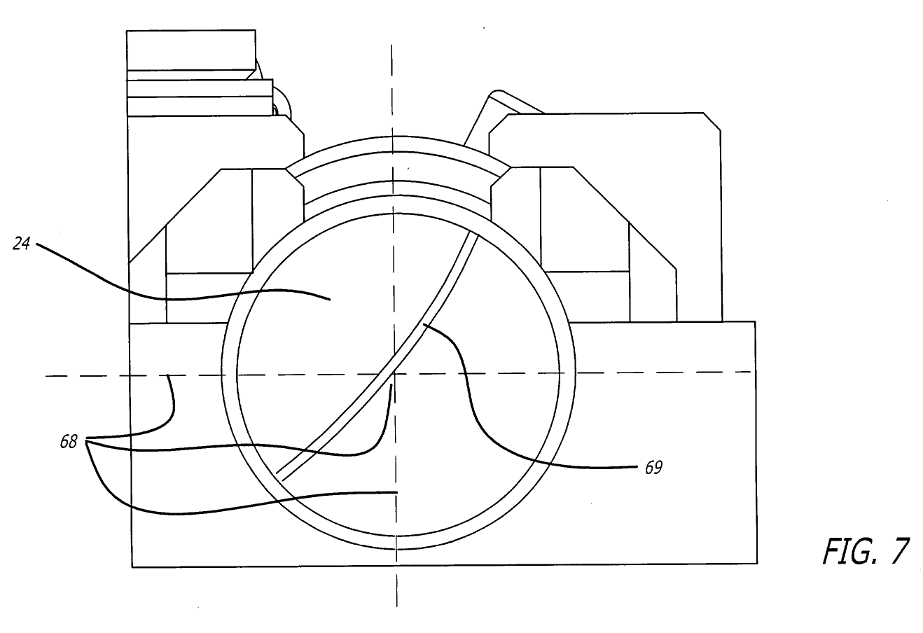

As shown in FIG. 7, the operator can view the front of the fiber optic cable 24 relative to another pair of visual markers 68 through the second camera 20 and monitor 22. The monitor 22 can be tuned to a different channel to view the front of the fiber 24. The marker 68 may be attached to the second camera 20. Some fiber optic cables contain lenses or have characteristics that require a certain angular orientation. The operator can manually spin the chuck 12 until a feature 69 of the fiber 24 is aligned with one of the markers 68. This provides proper angular orientation of the fiber 24.

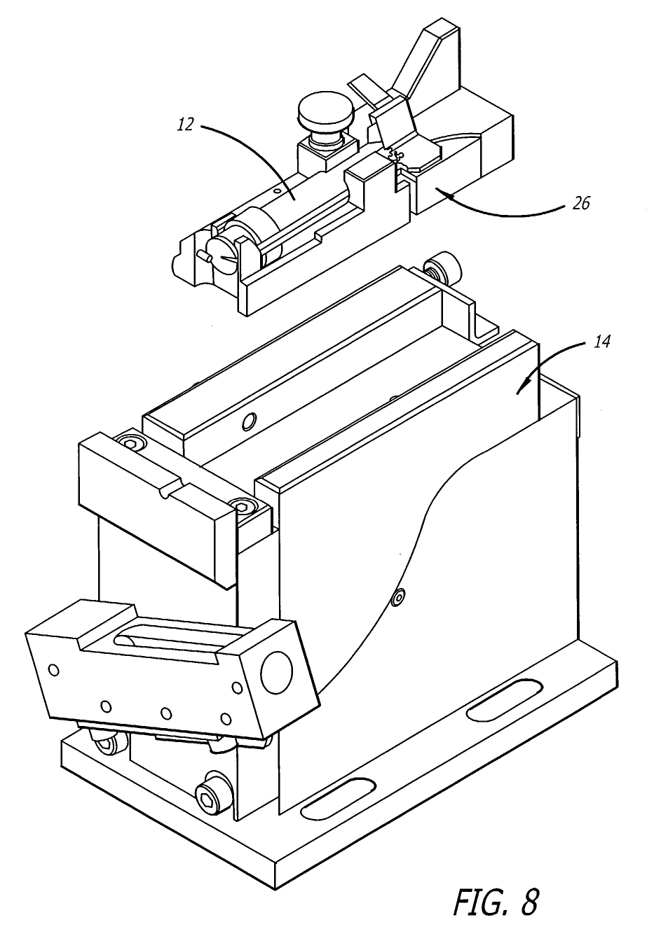

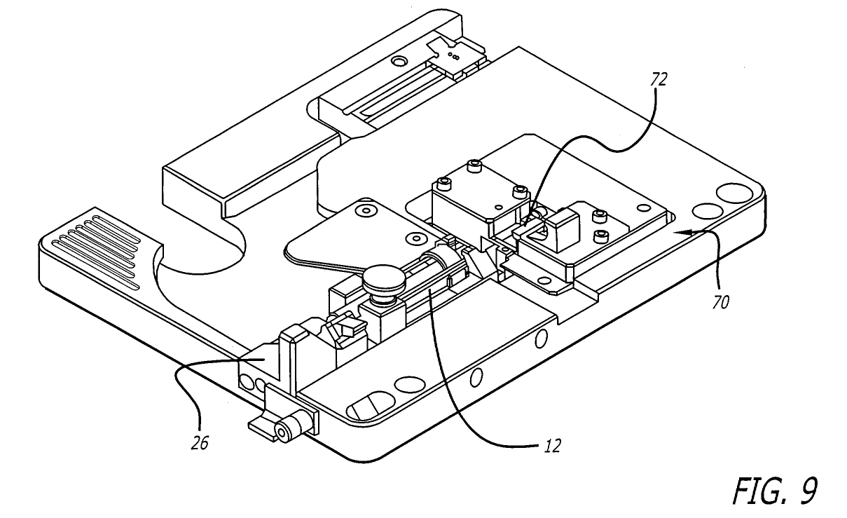

As shown in FIG. 8, after the fiber 24 is properly aligned, the fiber chuck 12 and substrate 26 can be removed from the base station 14. As shown in FIG. 9, the substrate 26 and fiber chuck 12 can then be placed into a pallet 70 that holds a package in a package nest 72. Because of the alignment at the fiber loading station 10 the fiber 24 is automatically aligned with the package when loaded into the pallet 70. The pallet 70 can then be loaded into a package assembly station (not shown) that attaches the fiber 24 to the package 72. By way of example, the package assembly station may be a laser weld machine such as the one shown and described in Application No. 973, 126, filed on Oct. 8, 2001, which is hereby incorporated by reference. The package assembly station is separate from the fiber loading station 10. An operator can load and align one fiber optic cable at the fiber loading station simultaneously with the solder or welding of another fiber cable to a package at a welding station. This parallel process reduces the time required to assemble the fiber 24 to the package 72.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed is:

1. A fiber loading station, comprising:
a fiber chuck assembly;
a base station that supports said fiber chuck assembly;
a first camera located above said base station; and,
a second camera located in front of said base station.

2. The station of claim 1, further comprising a monitor coupled to said first and second camera.

3. The station of claim 1, further comprising a first marker optically coupled to said first camera.

4. The station of claim 1, further comprising a second marker optically coupled to said second camera.

5. The station of claim 1, wherein said fiber chuck assembly includes a housing that includes a slit, a collar that slides over said housing and a spring biased lever arm that is coupled to said collar and said housing.

6. The station of claim 5, wherein said fiber chuck assembly includes a first screw coupled to said spring biased lever.

7. The station of claim 6, wherein said fiber chuck assembly includes a second screw coupled to said spring biased lever.

8. The station of claim 1, wherein said base station include a V-shaped groove.

9. The station of claim 1, further comprising a fiber chuck substrate that supports said fiber chuck assembly.

10. A fiber loading station, comprising:
chuck means for supporting a fiber optic cable;
base means for supporting said chuck means;
first camera means for aligning the fiber optic cable relative to said chuck means in a z direction; and,
second camera means for aligning a rotational position of the fiber optic cable.

11. The station of claim 10, further comprising a monitor coupled to said first andsecond camera means.

12. The station of claim 10, further comprising a first marker optically coupled to said first camera means.

13. The station of claim 10, further comprising a second marker optically coupled to said second camera means.

14. The station of claim 10, wherein said chuck means includes a housing that includes a slit, a collar that slides over said housing and a spring biased lever arm that is coupled to said collar and said housing.

15. The station of claim 10, wherein said chuck means includes force adjustment means for adjusting a force exerted onto the fiber optic cable.

16. The station of claim 10, wherein said chuck means includes position adjustment means for adjusting a position of the fiber optic cable.

17. The station of claim 10, wherein said base means include a V-shaped groove.

18. The station of claim 10, further comprising a fiber chuck base plate that supports said chuck means.

19. A method for aligning a fiber optic cable, comprising:
loading a fiber optic cable into a fiber chuck assembly;
positioning the fiber optic cable in a z direction while viewing the fiber optic cable through a first camera; and,
orienting the fiber optic cable while viewing the fiber optic cable through a second camera.

20. The method of claim 19, further comprising removing the fiber chuck assembly and the fiber optic cable from a base station and loading the fiber chuck assembly and fiber optic cable into a pallet.

21. The method of claim 20, further comprising placing the pallet into a package assembly station.

22. A fiber chuck assembly, comprising:
a housing that has a slit;
a spring biased lever coupled to said housing; and,
a collar that slides over said housing and is coupled to said spring biased lever.

23. The assembly of claim 22, further comprising a first screw coupled to said spring biased lever.

24. The assembly of claim 23, further comprising a second screw coupled to said spring biased lever.

25. The assembly of claim 22, further comprising an elastomeric pad attached to said spring biased lever.

26. A fiber chuck assembly, comprising:
a housing with means for supporting a fiber optic cable; and,
locking means for locking a position of the fiber optic cable.

27. The assembly of claim 26, further comprising force adjustment means for adjusting a force exerted onto the fiber optic cable.

28. The assembly of claim 26, further comprising position adjustment means for adjusting a position of the fiber optic cable.

29. The assembly of claim 26, wherein said locking means includes an elastomeric pad.

30. A method for assembling a fiber optic cable to a package, comprising:
loading a fiber optic cable into a fiber chuck assembly;
aligning the fiber optic cable within a fiber loading station;
removing the fiber chuck assembly and the aligned fiber optic cable from the fiber loading station;
loading the fiber chuck assembly and the aligned fiber optic cable into a package assembly station; and,
attaching the fiber optic cable to a package.

31. The method of claim 30, wherein the fiber chuck assembly is loaded into the fiber loading station after the fiber optic cable is loaded into the fiber chuck assembly.

32. The method of claim 30, wherein the fiber optic cable is aligned in a z direction.

33. The method of claim 30, wherein the fiber optic cable is aligned in a rotational direction.

34. The method of claim 30, further comprising loading the fiber chuck assembly into a pallet and loading the pallet and fiber chuck assembly into the package assembly station.

35. The method of claim 30, wherein the fiber optic cable is soldered to the package.
